(19) United States
(12) Patent Application Publication
(10) Pub. No.: US 2022/0416626 A1
(43) Pub. Date: Dec. 29, 2022

(54) SWITCHING DEVICE FOR AN ELECTRIC MOTOR AND ELECTRIC MOTOR

(71) Applicant: ELDOR CORPORATION S.P.A., Orsenigo (Como) (IT)

(72) Inventors: Luca ZAI, Torino (IT); Pasquale FORTE, Castiglione d'Orcia (Siena) (IT); Matteo SAVOIA, Orsenigo (Como) (IT)

(21) Appl. No.: 17/770,870

(22) PCT Filed: Oct. 20, 2020
(86) PCT No.: PCT/IB2020/059834

§ 371 Date: Apr. 21, 2022

(30) Foreign Application Priority Data
Oct. 23, 2019 (IT) 102019000019679

(51) Int. Cl. H02K 11/28; H02K 7/108

(52) U.S. Cl. CPC H02K 11/28; H02K 7/108

(57) ABSTRACT

A switching device for an electric motor comprises a fixed body, at least one moveable body that can be moved with respect to the fixed body between at least one first and one second position, in which the phases (104, 105, 016) are respectively in a first and a second electrical configuration, and a moving unit configured to move said moveable body between the first and the second position. This moving unit can be selectively coupled to the rotor of the electric motor so as to rotate with it and comprises a selecting device operationally placed between the rotor and the moveable body of the switching device and configured to transform each revolution of the rotor into a movement of the moveable body between the first and the second position.

This invention relates to a switching device for an electric motor and an electric motor comprising said switching device.

This invention is, therefore, particularly (but not exclusively) applicable to the automotive sector and, more precisely, to the design and manufacture of electric or electric/endothermic hybrid propulsion vehicles.

In relation to this sector, there has long been the need to extend the efficiency range of the electric motor in order to allow its use even in the absence of a mechanical transmission, or, in any case, in the presence of a simplified mechanical transmission.

To date, some methods are known, which are suitable for traction applications and use a suitable subdivision of the stator winding in different sections that can be selectively combined with each other in order to vary the motor “configuration”, thus being able to adapt it to the working conditions and extend its working range.

One such solution, perhaps the first, was studied by Eckart Nipp in his 1999 PhD thesis, which described a reconfigurable electric machine capable of achieving good performance in various operating conditions.

This solution, only illustrated on paper, has found limited application on the market, mainly due to its implementation/construction difficulties.

Until today, in fact, E. Nipp's idea has been developed and implemented by equipping motors with complex wiring and relays, the main drawbacks of which include the size, cost, and losses they introduce to the system.

Examples of these solutions are published in the patents WO2018/087689, U.S. Pat. No. 8,415,910 and WO2013/155601, that illustrate electrical machines with variable configuration equipped with several switches (at least 3 per phase) thanks to which each phase can change configuration.

In order to overcome these drawbacks, an innovative solution has recently been developed in which the switching device is electromechanical, consisting of a fixed body and a movable body that can be reciprocally moved so as to vary the electrical configuration of the stator, i.e. the connection between phases and/or phase fractions.

Despite its high technical/functional quality, this solution mostly requires an external actuator to move the moveable body in relation to the fixed body at the time of the “change”.

Given the high speeds and inertia involved, this could lead to problems in sizing the actuator and difficulties in designing systems that are both reliable and compact.

The purpose of this invention is, therefore, to provide a switching device for an electric motor that is able to overcome the drawbacks of the prior art described above.

In particular, the purpose of this invention is to provide a switching device that can be easily integrated into the electric motor and requires actuators that are easy to source or design.

In addition, the purpose of this invention is to provide a switching device for an electric motor that is very quick to implement and has low construction costs.

Said purposes are achieved with a switching device that has the technical features listed in one or more of the appended claims from 1 to 8, as well as with an electric motor that has the features of one or more of the claims from 9 to 12.

The electric motor comprises at least a first and a second phase extending between corresponding terminals.

Each phase is preferably provided with at least one first phase fraction and at least one second phase fraction, each extending between two ends.

Each terminal preferably corresponds to one end of a first or second phase fraction.

The switching device preferably comprises a fixed body equipped with a plurality of connection portions that can be joined to the ends of the first and second phase fraction and/or the terminals of each phase.

At least one moveable body is also, preferably, provided, which can be moved in relation to the fixed body between at least one first position and a second position.

In the first position, the moveable body arranges the phases in a first electrical configuration.

In the second position, the moveable body arranges the phases in a second electrical configuration.

It should be noted that the second electrical configuration is preferably separate from the first due to the connection between the first and second phase fraction within each phase and/or due to the reciprocal connection between the phases.

In addition, a moving unit is preferably provided and configured to move said moveable body between the first and the second position.

According to one aspect of the invention, the moving unit comprises a first rotating element and a second rotating element.

The first rotating element can be rotatably connected (i.e. in captive use) to the rotor of the electric motor, in order to rotate integrally with it.

The second rotating element is connected to the moveable body of the switching device and can be coupled with the first rotating element.

Preferably, moreover, the moving unit comprises an actuator operationally placed between the first and second rotating element.

The actuator is preferably configured to move the first and the second rotating element towards and apart from each other between a working position, in which the first and the second rotating element are rotatably connected, and a resting position, in which the first and the second rotating element are disconnected from each other.

The switching device preferably comprises a selecting device operationally placed between the second rotating element and the moveable body.

The selecting device is preferably configured to transform each revolution of the second rotating element into a movement of the moveable body between the first and second position.

Advantageously, in this way it is possible to exploit the rotor inertia to generate the movement of the moveable body between the first and the second position, requiring only a small actuator able to move the two rotating bodies away from and towards each other.

The selecting device preferably comprises at least one track made on said second rotating element and having at least one first portion and at least one second portion connected to each other by means of an exchange section.

There is at least one selection member linked to said track and moveable between at least one first operating position, in which it is linked to the first portion of the track, and a second operating position, in which it is linked to the second portion of the track.

A transmission unit is preferably placed between the selection member and the moveable body.

The transmission unit is preferably configured to position the moveable body in the first position when the selection member is in the first operating position and in the second position when the selection member is in the second operating position.

Advantageously, this system makes it possible to use rotor rotation as a power source for moving the moveable body at the critical actuation speeds required by the application, requiring an external actuator only for coupling/uncoupling operations, which are simpler and less stringent in terms of performance requirements.

The first portion of the track preferably comprises a first arc-shaped (of a circle) channel or profile of a smaller radius.

The second portion of the track comprises a second arc-shaped (of a circle) channel or profile of a greater radius.

Said arc-shaped channels therefore extend between two ends following the profile of a circumference, i.e. an arc of a circle.

Both channels or profiles preferably extend around a central axis of the second rotating element (i.e. the rotor rotation axis).

The exchange section connects said arc-shaped channels or profiles.

This exchange section preferably comprises, in addition, at least one moveable element between a first position, in which it allows the passage of the selection member from the first to the second portion, and a second position, in which it allows the passage of the selection member from the second to the first portion of the track.

More preferably, the exchange section comprises a first movable element linked to the first portion and a second movable element linked to the second portion.

The first element is moveable between a first position, in which it obstructs one exit end of the first portion, and a second position, in which it obstructs one entry end of the first portion of track.

The second element is movable between a first position, in which it obstructs one exit end of the second portion, and a second position, in which it obstructs one entry end of the second portion of track.

The exchange section preferably comprises a cross defined by a first and a second branch intersecting each other and each connected to one end of the first portion and one end of the second portion of track.

Each moveable element is configured to prevent the selection member from passing directly from the first to the second branch and vice versa.

Preferably, moreover, the selection member comprises an arm extending between a first end, slidably linked to said track, and a second, hinged end, and a fixed element (e.g. the casing of the electric motor).

The transmission unit preferably comprises a toothed coupling between said second end of the arm and said movable body shaped to transform a rotary mode of the arm into a corresponding (preferably counter-rotating) motion of the moveable body.

Advantageously, this system enables a quick and precise switching between the electrical configurations of the stator, being efficient and at the same time easily integrated into the machine.

These and other characteristics, together with the related technical benefits, will be clearer from the following illustrative, and therefore non-limiting, description of a preferred, and thus non-exclusive, embodiment of a switching device for an electric motor according to what is illustrated in the attached drawings, wherein:

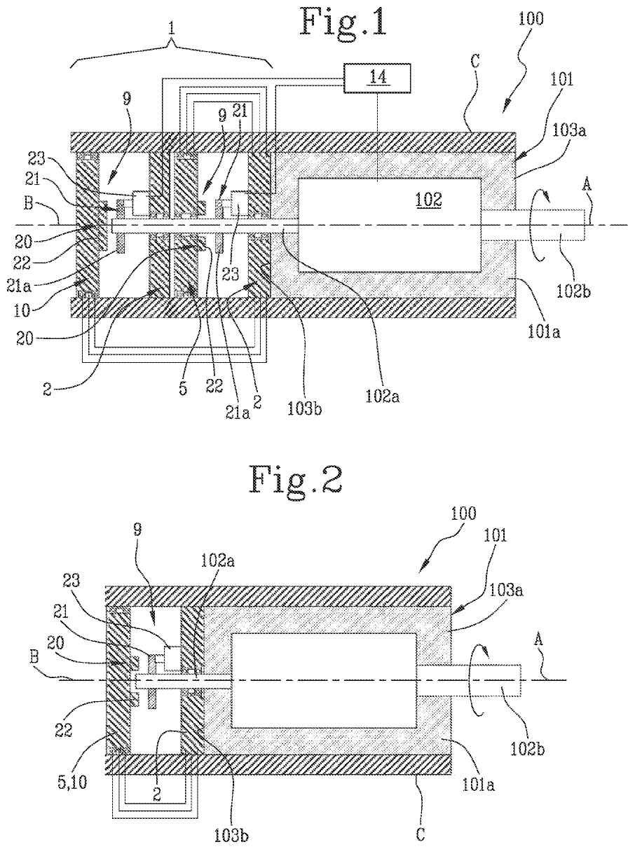

FIGS. 1 and 2 show respective, schematic cross-section views of an electric motor provided with a switching device according to this invention in two different embodiments;

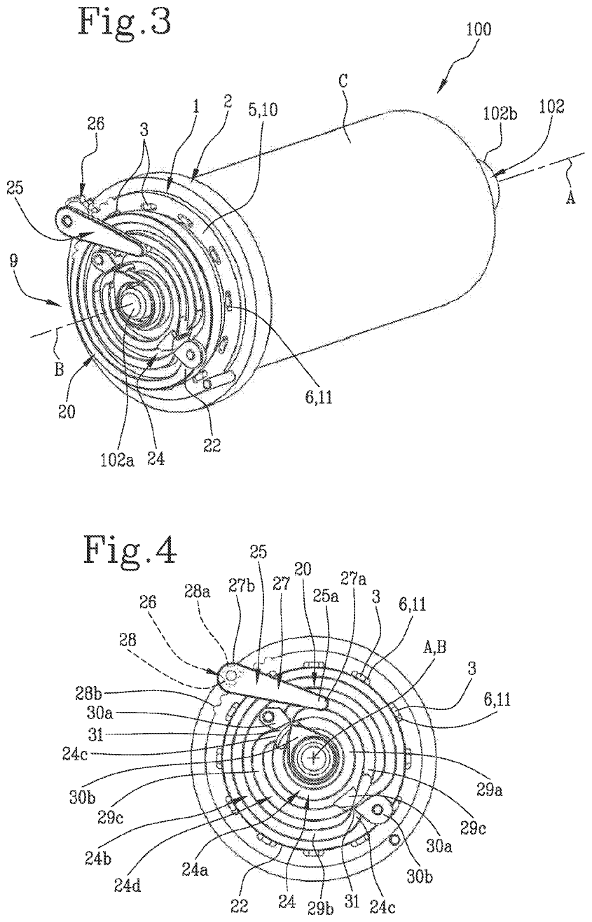

FIG. 3 shows a perspective view of the electric motor in FIG. 2;

FIG. 4 shows a front view of a switching device according to this invention provided with a moving unit;

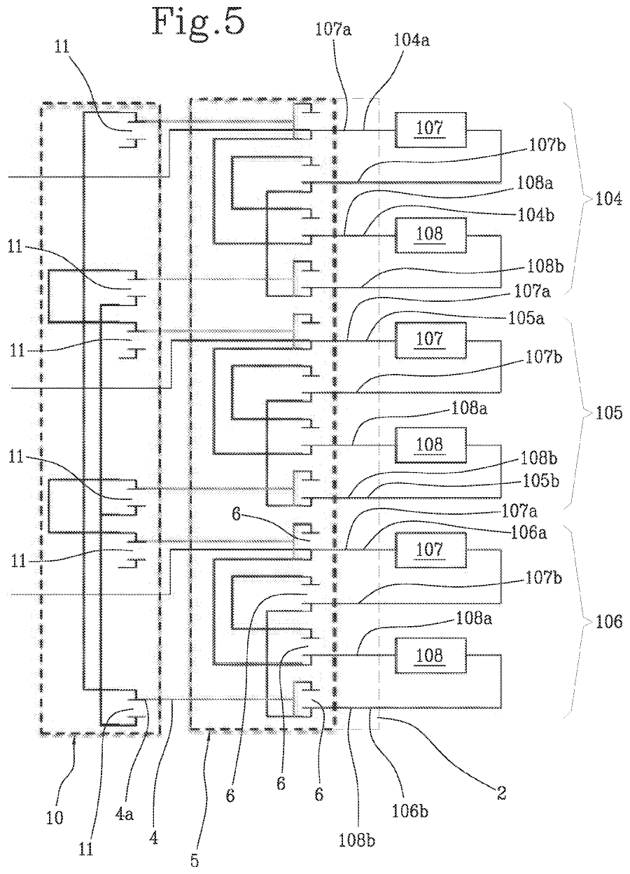

FIG. 5 shows an electrical layout representative of one preferred embodiment of the electric motor and the switching device in FIG. 1.

With reference to the appended figures, the reference number 1 indicates a switching device for an electric motor 100 according to this invention.

The switching device 1 is therefore connected, or can be connected, to an electric motor 100, preferably but not exclusively of the internal magnet type.

In particular, the electric motor 100 comprises a stator body, or stator 101, and a rotor body, or rotor 102, which is rotatably joined to the stator 101 to rotate about its own rotation axis “A”.

The stator body 101 is preferably housed inside a containment body “C” or casing.

The rotor 102 is preferably inserted into the stator 101 coaxially to it, at least to the stator cavity, and comprises a plurality of magnets, electromagnets, or windings designed to generate a magnetic field.

The stator 101, in turn, is provided with a prismatic casing 101a extending along said rotation axis “A” between two end faces 103a, 103b.

This casing 101a contains a plurality of phases 104, 105, 106 angularly spaced apart and defined by corresponding windings.

The phases can be of various types, but are preferably defined by bar conductors suitably arranged in corresponding slots formed in the casing and electrically connected to each other at at least one free end (i.e. at an end face 103a of the casing 101a).

The electric motor 100 is, therefore, of the multiphase type, i.e. comprising a number of phases ranging from two and increasing depending on the type or application.

In the preferred embodiment, however, the electric motor 100 is at least a three-phase motor.

In other words, in the embodiment illustrated (for illustrative purposes only), the stator 101 comprises at least a first 104, a second 105, and a third phase 106.

Each phase 104, 105, 106 extends between corresponding first 104a, 105a, 106a and second terminals 104b, 105b, 106b.

In the embodiment illustrated, the electric motor 100 preferably has fractionated phases.

Preferably, therefore, each phase 104, 105, 106 is provided with at least one first phase fraction 107 and at least a second phase fraction 108, both extending between a first end 107a, 108a and a second end 107b, 108b.

It should be noted that, in this respect, one end 107a of the first phase fraction 107 and one end 108b of the second phase fraction 108 correspond to the terminals 104a, 104b, 105a, 105b, 106a, 106b of the phases 104, 105, 106.

More precisely, the first end 107a of the first phase fraction 107 and the second end 108b of the second phase fraction 108 correspond, respectively, to the first 104a, 105a, 106a and the second terminal 104b, 105b, 106b of the corresponding first 104, second 105, or third phase 106.

In other words, each terminal 104a, 104b, 105a, 105b, 106a, 106b corresponds to an end 107a, 108b of a first 107 or second phase fraction 108.

The phase fractions 107, 108 of each phase 104, 105, 106 are like said coils or, preferably, bars (or sets of bars/hairpins) connected to each other.

The phases 104, 105, 106 and/or the phase fractions 107, 108 of each phase can be connected together in a suitable way in order to change the operating configuration of the electric motor 100.

Due to this, a switching device 1 configured to change the connection between the phases 104, 105, 106 and/or phase fractions 107, 108, in order to change the electrical configuration of the motor 100, is provided.

In particular, the switching device 1 is configured to actuate the change in configuration when a pre-fixed switching speed (or any other relevant parameter) is reached.

The switching device 1 comprises a fixed body 2 equipped with a plurality of connection portions 3 that can be joined to the ends 107a, 108a, 107b, 108b of the first 107 and second phase fraction 108 and/or to the terminals 104a, 104b, 105a, 105b, 106a, 106b of each phase 104, 105, 106.

The fixed body 2 is preferably made of aluminium.

In a preferred embodiment, the fixed body 2 is made in the form of a busbar in order to define the electrical connection between the conductor bundles of the winding of the electric motor 100.

The connection portions 3 are defined by seats where the free ends of the phases 104, 105, 106 or phase fractions 107, 108, which, as mentioned above, are preferably in the form of a bar (hairpin), are engaged.

It should be noted that, preferably, the connection portions 3 of the fixed body 2 correspond, in number, to the number of terminals or ends of the phase fractions 107, 108, depending on the embodiment.

In other words, in fractionated phase embodiments, the number of connection portions 3 of the fixed body 2 is preferably equal to twice the number of phases multiplied by the number of “fractions” (i.e. phase fractions) of each phase. In the illustrated embodiment, for example, the number of connection portions 3 is 12.

In non-fractionated phase embodiments, on the contrary, the number of connection portions 3 of the fixed body 2 could be limited to the number of phase terminals (i.e. twice the number of phases).

In addition, the fixed body 2 preferably comprises at least one connecting jumper 4 connected to each first 104a, 105a, 106a or second terminal 104b, 105b, 106b and extending from the corresponding terminal 104a, 104b, 105a, 105b, 106a, 106b to one free end 4a.

In other words, as will be better clarified below, a connecting jumper 4 is joined to each terminal 104a, 104b, 105a, 105b, 106a, 106b of a phase 104, 105, 106, each jumper defining an additional contact zone with said terminal 104a, 104b, 105a, 105b, 106a, 106b at its free end 4a.

The switching device 1 comprises at least one moveable body 5, 10 that can be moved in relation to the fixed body 2.

The moveable body 5, 10 can preferably be selectively moved in relation to the fixed body 2 between at least one first and one second position.

In the first position, the moveable body 5, 10 arranges the phases 104, 105, 106 in a first electrical configuration.

In the second position, the moveable body 5, 10 preferably arranges the phases in a second electrical configuration.

The second electrical configuration is separate from the first one due to the connection between the first 107 and the second phase fraction 108 within each phase 104, 105, 106 and/or due to the reciprocal connection between the phases 104, 105, 106.

In other words, the movement of the moveable body 5, 10 in relation to the fixed body 2 ensures that the electrical configuration of the electric motor 1 is modified by at least one first to at least one second configuration.

Structurally, in this respect, the moveable body 5, 10 preferably has a plurality of contact portions 6, 11 each joined to a corresponding end 107a, 108a, 107b, 108b or a corresponding terminal 104a, 104b, 105a, 105b, 106a, 106b of the phase 104, 105, 106.

Each contact portion 6, 11 comprises at least one first and one second connecting point separate and positioned so that the first point contacts the corresponding end or terminal in the first position and the second point contacts the corresponding end or terminal in the second position of the moveable body 5, 10.

According to this invention, the switching device 1 comprises a moving unit 9 configured to move said moveable body 5, 10 between the first and the second position.

The moving unit 9 can be selectively coupled with the rotor 102 in order to rotate with it and use its inertia to move the moveable body between the first and second position.

More precisely, the moving unit 9 comprises a selecting device 20 operationally placed between the rotor 102 and the moveable body 5, 10 of the switching device 1.

The selecting device 20 is configured to transform each rotor revolution 102 into a movement of the moveable body 5, 10 between the first and second position.

Advantageously, in this way, the synchronisation of the rotor and the moving unit, which rotating with the rotor enables maximum actuation speed and thus overcomes the drawbacks found in the prior art, is ensured.

The moving unit 9 preferably comprises a first rotating element 21 rotatably connected (or attached) to the rotor 102 to rotate integrally with it.

The first rotating element 21 is preferably fitted to a shaft 102a that is coaxial to the rotor 102 and is bound to rotate with it.

The moving unit 9 comprises, in addition, a second rotating element 22 connected to said moveable body 5, 10 and that can be selectively coupled with the first rotating element 21.

In this respect, an actuator 23 operationally placed between the first 21 and second rotating element 22 is preferably provided.

The actuator 23 is configured to move these first 21 and second rotating elements 22 close to and away from each other between a working position and a resting position.

In the working position, the first 21 and the second rotating element 22 are rotatably connected to each other, so that the first rotating element 21 transmits the rotation of the rotor 102 (i.e. of the shaft 102a) to the second rotating element 22.

In the resting position, the first 21 and the second rotating element 22 are attached to each other. Therefore, the first rotating element is free to rotate integrally with the rotor 102 while the second rotating element is idle or blocked in a specific position.

The first rotating element 21 preferably comprises a clutch disk 21a fitted to the shaft 102a and slidably linked to it to move between said working and resting positions.

In other words, the first rotating element 21 (in particular, the clutch disk 21a) is rotatably connected and, at the same time, slidably linked to the shaft 102a.

The actuator 23 is preferably of the linear type and is configured to translate the first rotating element along the shaft 102a between a position removed from the second rotating element 22, corresponding to the resting position, and a position close to, in particular in contact with, the second rotating element 22.

In the preferred embodiment, the actuator 23 is defined by a hydraulic or pneumatic piston. Alternatively, in any case, this actuator could also be of another kind, for example electric.

The selecting device 20 is connected to the second rotating element 22 and is placed (structurally and/or operationally) between said second rotating element 22 and the moveable body 5, 10 of the switching device 1.

As mentioned above, the task of the selecting device 20 is to transform each revolution of the second rotating element 22 (and thus of the rotor 102) into a movement of the moveable body 5, 10 between the first and second position.

The selecting device 20 makes it possible to “select” (hence the name) the position of the moveable body 5, 10 and, thus, the electrical configuration of the motor 100, depending on the rotor rotation.

The selecting device 20 preferably comprises at least one track 24, a selection member 25, and a transmission unit 26.

The track 24 is made on said second rotating element 22 and has at least one first portion 24a and at least one second portion 24b connected to each other by means of an exchange section 24c.

The selection member 25 is, thus, linked to said track 24 and is moveable between at least one first operating position, in which it is linked to the first portion of the track 24a, and a second operating position, in which it is linked to the second portion of the track 24b.

The transmission unit 26 is placed between the selection member 25 and the moveable body 5, 10 and is configured to position the moveable body 5, 10 in the first and in the second position respectively when the selection member 25 is in the first operating position and in the second operating position.

It should be noted that the track 24 preferably defines a cam profile and the selection member 25 comprises a cam follower 25a slidably linked to the cam (i.e. to the track).

Therefore, a movement of the track 24, along which the selection member 25 runs, in particular the cam follower 25a, corresponds to a rotation of the second rotating element 22.

In particular, the selection member 25 comprises an arm 27 extending between one first end 27a and one second end 27b.

The first end 27a is slidably linked to the track 24; therefore, in the preferred embodiment, the first end 27a of the arm 27 defines the cam follower 25a.

The second end 27b is hinged to a fixed element (in relation to the moveable body 5, 10 and to the moving unit 9).

This second end 27b is preferably hinged to the fixed body 2 of the switching device, to the stator 101, or to the casing X of the electric motor 100.

The transmission unit 26 comprises, thus, a toothed coupling 28 between the second end 27b of the arm 27 and the moveable body 5, 10.

This toothed coupling 28 is shaped to transform a rotary motion of the arm 27 around its own pin axis “C” into a corresponding movement of the moveable body 5, 10.

The movement of the moveable body 5, 10 can be rotary or translatory, preferably counter-rotatory in relation to the arm 27.

In the preferred embodiment, the toothed coupling 28 comprises a toothed wheel 28a attached to the arm 27 and a toothed profile 28b (linear or curved) that is integral with the moveable body 5, 10.

The arm 27 is, therefore, configured to oscillate around its own pin axis between a plurality of angular positions determined by the track 24, determining the movement of the moveable body 5, 10 between the first and the second position as a function of this oscillation.

In more detail, the track 24 is preferably defined by a plurality of arc-shaped channels or profiles, preferably an arc of a circle. As mentioned above, the arc-shaped channels or profiles preferably follow an arc of a circle between two respective ends and each have a constant radius with respect to the central axis “B”.

The first portion 24a of the track 24 preferably comprises at least one first arc-shaped channel 29a or profile with a smaller radius.

The second portion 24b of the track 24 comprises at least one second arc-shaped channel 29b or profile with a smaller radius.

Both the arc-shaped (of a circle) channels or profiles extend around a central axis “B” of the second rotating element 22, i.e. of the rotor 102.

Each first arc-shaped channel 29a is connected to a corresponding second arc-shaped channel 29b by means of a corresponding exchange section 24c.

The exchange section 24c preferably comprises at least one moveable element 30a, 30b between a first position, wherein it allows the passage of the selection member 25 from the first 24a to the second portion 24b, and a second position, wherein it allows the passage of the selection member 25 from the second 24b to the first portion 24a.

More precisely, the exchange section 24c comprises a first moveable element 30a linked to the first portion 24a and a second moveable element 30b linked to the second portion 24b.

The first moveable element 30a is moveable between a first position, in which it obstructs one exit end of the first portion 24a, and a second position, in which it obstructs one entry end of the first portion 24a of track 24.

Similarly, the second moveable element 30b is movable between a first position, wherein it obstructs one exit end of the second portion 24b, and a second position, wherein it obstructs one entry end of the second portion 24b of track 24.

It should be noted that, preferably, the first moveable element 30a in the second position faces the second moveable element 30b in the first position, thus defining a first passage channel for the selection member 25 from the exit end of the first portion 24a to the entry end of the second portion 24b.

In addition, the first moveable element 30a in the second position faces the second moveable element 30b in the first portion, thus defining a second passage channel for the selection member 25 from the exit end of the second portion 24b to the entry end of the first portion 24a.

Advantageously, in this way, the correct reciprocal moving between the track 24 and the selection member 25 is ensured, avoiding system malfunctions.

More specifically, the exchange section 24c preferably comprises a cross 31 defined by a first and a second branch intersecting each other and each connected to one end (entry or exit) of the first 24a and of the second portion 24b of track 24.

In particular, the first branch preferably extends between the exit end of the first portion 24a and the entry end of the second portion 24b of track 24.

The second branch extends between the exit end of the second portion 24b and the entry end of the first portion 24a of track 24.

It should be noted that, in this respect, each moveable element 30a, 30b is configured to prevent the selection member 25 from passing directly from the first to the second branch and vice versa. Advantageously, this maximises the system's reliability.

Each moveable element 30a 30b preferably comprises a springback member (not illustrated) designed to enable the movement of the same between the first and the second position following a pre-fixed thrust action and configured to return the moveable element 30a, 30b from the second to the first position at the completion of this action.

Therefore, the first position of the moveable element 30a, 30b is preferably a considerably stable position, while its second position is a considerably unstable position.

Advantageously, in this way, the moveable element 30a, 30b is autonomously driven by the selection member 25 (in particular by the cam follower 25a) in its movement along the track, avoiding the necessity of using active actuators or selectors that necessitate control.

The switching device comprises, in addition, a control unit 14 joined to the moving unit 9 in order to drive it, according to the operating conditions of the electric motor 100.

This control unit 14 is preferably joined to the vehicle's control unit or sensor means capable of transmitting information related to the operating parameters of the vehicle and/or the electric motor 100 itself.

In the embodiment described here, the control unit 14 is linked to the actuator 23 and is configured to drive it in accordance with the operating conditions of the electric motor 100.

In particular, the control unit 14 is configured to drive the actuator 23 so as to move the first rotating element 21 from the resting position to the working position when the rotor reaches the switching speed.

Specifically, on receiving a signal indicating that the switching speed has been reached, the control unit 14 is programmed to send a signal representing a movement from the resting position to the working position to the actuator 23.

In addition, the control unit 14 is configured to keep the first rotating element 21 in the working position for a number of rotor revolutions 102 corresponding to the displacement of the moveable body 5, 10 from the first to the second position.

Finally, the control unit 14 is configured to guide the actuator 23 so as to move the first rotating element 21 from the working position to the resting position when said number of revolutions is reached.

In other words, on receiving a signal representing the attainment of said number of revolutions (or, in any case, identifying the configuration change), the control unit 14 is programmed to send a signal representing a movement from the working position to the resting position to the actuator 23, thus detaching the first 21 from the second moveable body 22 and stopping the movement of the selection member 25 in the track 24.

Advantageously, the solution described until this point significantly facilitates the execution of the switching, limiting the electronics necessary to driving a simple, linear actuator 23—simple to source/design and, above all, to integrate into the system.

It should be noted that, in the preferred embodiment, the shaft 102a to which the first rotating element 21 is coupled exits (i.e. protrudes from) the rear of the rotor 102. In other words, the shaft 102a extends in the opposite direction to the end for connecting the charge to the motor, considered to be the front end in this text.

Therefore, according to a preferred embodiment of the invention, the casing 101a of the stator 101 extends between two end faces 103a, 103b wherein a power shaft 102b of the motor 100 protrudes from a first face 103a (front), the shaft being coupled to a charge, and said shaft 102a, or auxiliary shaft, protrudes from a second end face 103b (rear).

Advantageously, this makes it possible to position the switching device 1 and the moving unit 9 in a zone of the electric motor 100 that does not involve the elements for mechanically transmitting motion, rationalising the dimensions and facilitating both the installation and the maintenance.

In accordance with a preferred embodiment of the invention, the moveable body 5, 10 of the switching device can be moved in relation to the fixed body 2, including into a third position.

In the third position (separate from the first and second) an electrical circuit defined by said phases 104, 105, 106 is in an open condition.

In other words, the third position is a neutral position wherein the stator phases are in a non-conductive state.

Advantageously, this makes it possible to run the motor in idle, for example, keeping the rotor firmly bound to the vehicle's wheel assembly without the need to introduce a clutch or disconnect clutch to operate when the electric motor is not operating.

The moveable body 5, 10 can preferably be moved along a stroke that goes from the first to the second position, in which said third position is intermediate between said first and said second position.

In accordance with this embodiment, the moving unit 9 also has some additional features.

In particular, the moving unit 9 is preferably configured to transform each revolution of the second rotating element into a movement of the moveable body 5, 10 between the first, the second position, and the third.

In this respect, the second rotating element 22 preferably has a track 24 that is also equipped with a third portion 24d, connected to the first 24a and/or to the second portion 24b by means of one or more exchange sections 24c (refer to the previous paragraphs for a detailed description of such).

The selection member 25 can, thus, be moved in at least one third operating position, additional to the first two, and the transmission unit 26 is configured to position the moveable body 5, 10 into the third position when the selection member is in the third operating position.

In the preferred embodiment, the third track 24d is placed between the first 24a and the second 24b; there are, therefore, two exchange sections 24c, one between the first 24a and the third portion 24d, and one between the third 24d and the second portion 24b.

More precisely, the third portion 24d of the track 24 comprises at least one third arc-shaped channel 29c or profile, with a medium radius between the first 29a and the second channel 29b.

More specifically, in this embodiment, the track 24 comprises:

a first channel 29a, with a smaller radius, extending around the central axis “B” between an entry end and an exit end;

a first exchange section provided with a first and a second branch that intersect, branching out respectively from the entry end and the exit end;

a third channel 29b, with a medium radius, extending in a position radially external to the first channel 29a between an entry end, connected to the second branch of the first exchange section, and an exit end;

a third channel 29b, with a medium radius, extending in a position radially external to the first channel 29a between an entry end and an exit end, connected to the first branch of the first exchange section;

a second exchange section provided with a first and a second branch that intersect and branching out, respectively, from the entry end of a third channel 29d and from the exit end of the other third channel 29d;

a second channel 29b, with a larger radius, extending around the third channels 29d between an entry end and an exit end connected, respectively, to the second and to the first branch of the second exchange section 29d.

It should be noted that, in a preferred embodiment, the switching device 1 comprises a first 5 and a second moveable body 10, which are moveable independently and reciprocally in relation to each other.

In other words, both the first 5 and the second moveable body 10 can be moved into respective first and second positions independently of each other.

In this way, the switching device 1 enables a plurality of operating configurations to be defined; this plurality is equal to the product of the number of positions that can be assumed by the first 5 and the second moveable body 10.

With reference to the preferred embodiment, the switching device 1 makes it possible to obtain one or more of the following operating configurations:

a delta-series configuration, in which the first moveable body 5 is in the first position and the second moveable body 10 is in the second position;

a delta-parallel configuration, in which both the first moveable body 5 and the second moveable body 10 are in the second position;

a star-series configuration, in which the first moveable body 5 is in the second position and the second moveable body 10 is in the first position;

a star-parallel configuration, in which both the first moveable body 5 and the second moveable body 10 are in the first position.

In this embodiment, therefore, the switching device 1 could comprise two moving units 9, both linked to the rotor 102 and able to be moved independently in their respective operating positions.

The invention achieves its intended purposes and significant advantages are thus obtained.

In fact, the presence of a switching device able to vary the electrical configuration of the motor without needing to provide an actuator capable of synchronising with the rotation of the rotor significantly simplifies the design and driving of the electric motor.

In addition, by exploiting the intrinsic synchronisation of the rotor with an element rotatably connected to it, the actuation speed of the moving unit is maximised, as is the system efficiency.

1. A switching device for an electric motor, said motor comprising a rotor rotating inside a stator that has a plurality of phases (104, 105, 106) extending between respective terminals, wherein said switching device comprises:
a fixed body provided with a plurality of connection portions configured to be linked to the terminals of the phases;
at least one moveable body that can be moved with respect to the fixed body between at least one first and one second position, wherein the phases are respectively in a first and a second electrical configuration;
a moving unit configured to move said moveable body between the first and the second position;
characterised in that said moving unit comprises:
a first rotating element rotatably connectable to said rotor in order to integrally rotate with it;
a second rotating element connected to said moveable body and that can be coupled with said first rotating element;
an actuator operationally placed between said first and said second rotating element and configured to move them towards and apart from each other between a working position, in which the first and the second rotating element are rotatably connected, and a resting position, in which the first and the second rotating element are disconnected from each other;
a selecting device operationally placed between the second rotating element and the moveable body and configured to transform each revolution of the second rotating element into a movement of the moveable body between the first and the second position.

2. The switching device according to claim 1, wherein the selecting device comprises:
at least one track made on said second rotating element and having at least one first portion and at least one second portion connected to each other by means of an exchange section;
at least one selection member linked to said track and moveable between at least one operating position, in which it is linked to the first portion of the track, and a second operating position, in which it is linked to the second portion of the track;
a transmission unit placed between the selection member and the moveable body and configured to:
position the moveable body in the first position when the selection member is in the first operating position;
position the moveable body in the second position when the selection member is in the second operating position.

3. The switching device according to claim 2, wherein said at least one track defines a cam profile and said selection member is defined by a cam follower.

4. The switching device according to claim 2, wherein:
said first portion of the track comprises a first arc-shaped channel or profile of a smaller radius;
said second portion of the track comprises a second arc-shaped channel or profile, of a greater radius, wherein both said first and second channel extend around a central axis of said second rotating element and are connected to each other by means of said exchange section.

5. The switching device according to claim 2, wherein said exchange section comprises at least one moveable element between a first position, in which it allows the passage of the selection member from the first to the second portion, and a second position, in which it allows the passage of the selection member from the second to the first portion.

6. The switching device according to claim 5, wherein the exchange section comprises a first moveable element linked to the first portion and a second moveable element linked to the second portion, wherein:
said first moveable element is moveable between a first position, in which it obstructs one exit end of the first portion, and a second position, in which it obstructs one entry end of the first portion of track;
said second moveable element is movable between a first position, in which it obstructs one exit end of the second portion, and a second position, in which it obstructs one entry end of the second portion of track.

7. The switching device according to claim 6, wherein each exchange section comprises a cross defined by a first and a second branch intersecting each other and each connected to one end of the first portion and one end of the second portion of track,
and wherein each moveable element is configured to prevent the selection member from passing directly from the first to the second branch and vice versa.

8. The switching device according to, claim 2, wherein the selection member comprises an arm extending between a first end slidably linked to said track, and a second end, hinged to a fixed element; said transmission unit comprising a toothed coupling between said second end of the arm and said moveable body shaped to transform a rotary mode of the arm into a corresponding movement of the moveable body.

9. An electric motor comprising:
a casing;
a stator housed in the casing and provided with a plurality of phases extending between their respective terminals;
a rotor rotating inside said stator around a central axis;
a switching device comprising:
a fixed body connected to said casing and/or said stator and provided with a plurality of connection portions linked to the terminals of the phases;
at least one moveable body that can be moved with respect to the fixed body between at least one first and one second position, wherein the phases are respectively in a first and a second electrical configuration;
a moving unit configured to move said moveable body between the first and the second position;
characterised in that said moving unit can be selectively coupled with said rotor so as to rotate with it and comprises a selecting device:
operationally placed between the rotor and the moveable body of the switching device
and configured to transform each rotor revolution into a movement of the moveable body between the first and second position.

10. The electric motor as claimed in claim 9, wherein said moving unit comprises:
a first rotating element that is rotatably connected to said rotor in order to integrally rotate with it;
a second rotating element connected to said moveable body and that can be coupled with said first rotating element;
an actuator operationally placed between said first and said second rotating element and configured to move them towards and apart from each other between a working position, in which the first and the second rotating element are rotatably connected, and a resting position, in which the first and the second rotating element are disconnected from each other; said selecting device being operationally placed between the second rotating element and the moveable body and configured to transform each revolution of the second rotating element into a movement of the moveable body between the first and second position.

11. The electric motor according to claim 10, wherein the first rotating element comprises a clutch disk fitted to a shaft of coaxial rotation to said rotor and slidably linked to it to move between said working and resting positions.

12. The electric motor according to claim 10, wherein said rotor has at least one switching speed from the first to the second electrical configuration of the phases of the stator; said motor comprising a control unit linked to the moving unit and configured to:
drive the actuator to move the first rotating element from the resting position to the working position when the rotor reaches said switching speed;
keep the first rotating element in the working position for a number of rotor revolutions corresponding to the displacement of the moveable body from the first to the second position;
guide the actuator to move the first rotating element from the working position to the resting position when said number of revolutions is reached.
